(19) United States
(12) Patent Application Publication
(10) Pub. No.: US 2026/0245232 A1
(43) Pub. Date: Aug. 20, 2026

(54) LEARNING DEVICE, SYMMETRY EVALUATION DEVICE, LEARNING METHOD, AND RECORDING MEDIUM

(71) Applicant: NEC CORPORATION, Minato-ku, Tokyo (JP)

(72) Inventor: Koichi TAKAHASHI, Tokyo (JP)

(73) Assignee: NEC CORPORATION, Minato-ku, Tokyo (JP)

(21) Appl. No.: 18/851,165

(22) PCT Filed: Mar. 30, 2022
(86) PCT No.: PCT/JP2022/016200

§ 371 Date: Sep. 26, 2024

(51) Int. Cl. G06T 7/68; G06N 3/0464; G06V 10/75; G06V 10/77

(52) U.S. Cl. CPC G06T 7/68; G06N 3/0464; G06V 10/751; G06V 10/7715; G06T 2207/20081

(57) ABSTRACT

This learning device acquires training data that includes an original image; generates an inverted image in which the original image is axisymmetrically inverted; calculates the coordinates of feature points of the original image and the coordinates of feature points of the inverted image; calculates a symmetry evaluation value that indicates the degree of difference between the coordinates of the feature points of the original image and the coordinates of the feature points of the inverted image in a case where coordinate conversion is performed so as to cancel out the difference in coordinates between the coordinates of the feature points of the original image and the coordinates of the feature points of the inverted image due to the effect of image inversion; and controls the training of a model used for calculating the coordinates such that the degree of difference indicated by the symmetry evaluation value is reduced.

### TECHNICAL FIELD

The present invention relates to a learning device, a symmetry evaluation device, a learning method, and a recording medium.

### BACKGROUND ART

In the processing of facial images, a facial image in which an original facial image has been horizontally inverted is sometimes used in addition to the original facial image.

For example, Patent Document 1 describes that, in a case where performing pattern recognition of facial images, a facial image in which an original facial image has been horizontally inverted is used in addition to the original facial image in order to reduce the number of sample facial images to be prepared as much as possible.

For example, the image processing device described in Patent Document 1 stores a plurality of normalized facial image data, and calculates and stores in advance the average image data, variance image data, and covariance matrix data for all of the plurality of facial image data, and facial image data obtained by horizontally inverting the plurality of facial image data. In a case where a new input facial image is obtained, the image processing device refers to the average image data, variance image data, and covariance matrix data, and calculates a Mahalanobis distance between the input facial image and the feature information of the stored facial images. If the calculated Mahalanobis distance is smaller than a predetermined value, the image processing device outputs a control signal indicating that the input facial image is close to a stored facial image.

Furthermore, Patent Document 2 describes learning using teacher data and learning using a mirror image of the teacher data in order to evaluate the reliability of a facial image detected by face detection.

In the image processing device described in Patent Document 2, a face detection means detects a substantially frontal facial image using a detector that has been trained using teacher data to detect substantially frontal facial images. A face evaluation means evaluates a reliability of the facial image detected by the face detection means.

In addition, a mirror image detection means detects a substantially frontal facial image using a detector that has been trained using a mirror image of the teacher data mentioned above to detect substantially frontal facial images. A facial image reevaluation means increases the reliability of the facial image detected by the face detection means in a case where the mirror image detection means detects a facial image having a region that overlaps the facial image detected by the face detection means by a predetermined ratio or more.

### PRIOR ART DOCUMENTS

### Patent Documents

Patent Document 1: Japanese Unexamined Patent Application, First Publication No. 2000-187733

Patent Document 2: Japanese Unexamined Patent Application, First Publication No. 2010-160640

### SUMMARY OF THE INVENTION

### Problems to be Solved by the Invention

In a case where learning the image processing of a target object having an orientation, such as facial image processing, if it is possible to reflect, in the learning result, the symmetry between an original image and an image in which the original image has been axisymmetrically inverted, it is expected that processing that is robust to the orientation of the target object can be learned.

An example object of the present disclosure is to provide a learning device, a symmetry evaluation device, a learning method, and a recording medium that are capable of solving the above problem.

### Means for Solving the Problem

According to a first example aspect of the present invention, a learning device includes: a training data acquisition means that acquires training data that includes an original image; an image inversion means that generates an inverted image in which the original image is axisymmetrically inverted; a feature point coordinate calculation means that calculates coordinates of feature points of the original image and coordinates of feature points of the inverted image; a symmetry evaluation value calculation means that calculates a symmetry evaluation value that indicates a degree of difference between the coordinates of the feature points of the original image and the coordinates of the feature points of the inverted image in a case where coordinate conversion is performed so as to cancel out a difference in coordinates between the coordinates of the feature points of the original image and the coordinates of the feature points of the inverted image due to an effect of image inversion; and a learning control means that controls the learning of the feature point coordinate calculation means such that the degree of difference indicated by the symmetry evaluation value is reduced.

According to a second example aspect of the present invention, a symmetry evaluation device includes: an output means that outputs a symmetry evaluation value that indicates a degree of difference between coordinates of feature points of an original image and coordinates of feature points of an inverted image, in which the original image has been axisymmetrically inverted, in a case where coordinate conversion is performed so as to cancel out a difference in coordinates between the coordinates of the feature points of the original image and the coordinates of the feature points of the inverted image due to an effect of image inversion.

According to a third example aspect of the present invention, a learning method causes a computer to perform the steps of: acquiring training data that includes an original image, and correct values of coordinates of feature points of the original image; generating an inverted image in which the original image is axisymmetrically inverted; calculating coordinates of feature points of the original image and coordinates of feature points of the inverted image; calculating a symmetry evaluation value that indicates a degree of difference between the coordinates of the feature points of the original image and the coordinates of the feature points of the inverted image in a case where coordinate conversion is performed so as to cancel out a difference in coordinates between the coordinates of the feature points of the original image and the coordinates of the feature points of the inverted image due to an effect of image inversion; and controlling learning of a model that calculates the coordinates of the feature points such that the degree of difference indicated by the symmetry evaluation value is reduced.

According to a fourth example aspect of the present invention, a recording medium stores a program that causes a computer to execute the steps of: acquiring training data that includes an original image, and correct values of coordinates of feature points of the original image; generating an inverted image in which the original image is axisymmetrically inverted; calculating coordinates of feature points of the original image and coordinates of feature points of the inverted image; calculating a symmetry evaluation value that indicates a degree of difference between the coordinates of the feature points of the original image and the coordinates of the feature points of the inverted image in a case where coordinate conversion is performed so as to cancel out a difference in coordinates between the coordinates of the feature points of the original image and the coordinates of the feature points of the inverted image due to an effect of image inversion; and controlling learning of a model that calculates the coordinates of the feature points such that the degree of difference indicated by the symmetry evaluation value is reduced.

### Effect of Invention

According to the present invention, in a case where learning the image processing of a target object having an orientation, it is possible to reflect, in the learning result, the symmetry between image data and image data in which the image data has been axisymmetrically inverted.

### BRIEF DESCRIPTION OF THE DRAWINGS

FIG. 1 is a diagram showing an example of a configuration of a learning device according to an example embodiment.

FIG. 2 is a diagram showing an example of data input and output in the learning device according to the example embodiment.

FIG. 3 is a diagram showing an example of a configuration of a face recognition device using a feature point coordinate calculation unit that has been trained by the learning device according to the example embodiment.

FIG. 4 is a diagram showing an example of the processing procedure by which the learning device according to the example embodiment performs the learning of a feature point coordinate calculation unit.

FIG. 5 is a diagram showing an example of the processing procedure by which the face recognition device according to the example embodiment performs face recognition.

FIG. 6 is a diagram showing another example of a configuration of a learning device according to the example embodiment.

FIG. 7 is a diagram showing an example of the processing procedure of a learning method according to the example embodiment.

FIG. 8 is a schematic block diagram showing a configuration of a computer according to at least one example embodiment.

### EXAMPLE EMBODIMENT

Hereunder, an example embodiment of the present example embodiment will be described. However, the following example embodiment does not limit the invention according to the claims. Furthermore, not all combinations of features described in the example embodiment are essential to the solution means of the invention.

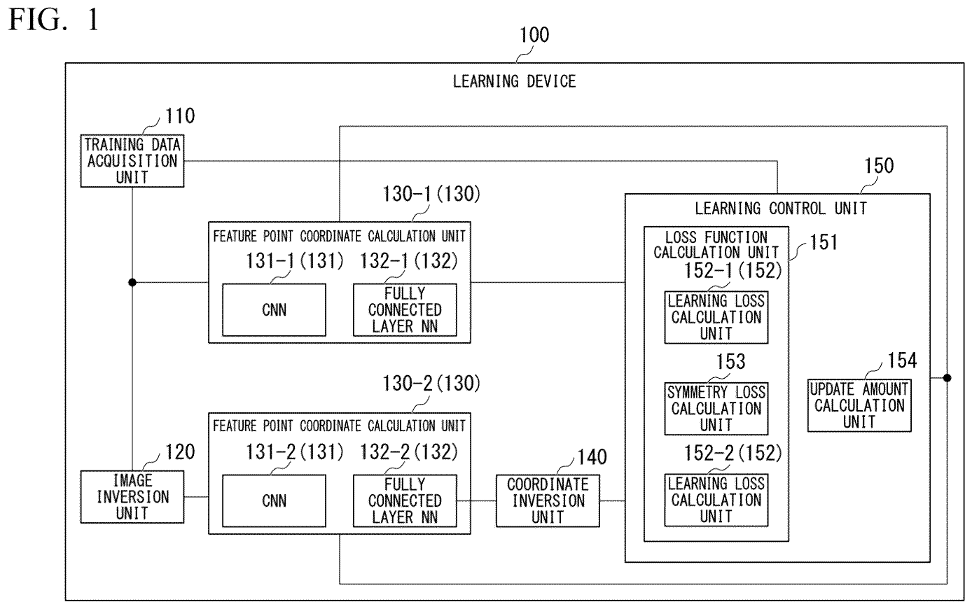

FIG. 1 is a diagram showing an example of a configuration of a learning device according to the example embodiment. In the configuration shown in FIG. 1, the learning device 100 includes a training data acquisition unit 110, an image inversion unit 120, feature point coordinate calculation units 130, a coordinate inversion unit 140, and a learning control unit 150. The feature point coordinate calculation units 130 include a convolutional neural network 131 and a fully connected layer neural network 132. The learning control unit 150 includes a loss function calculation unit 151 and an update amount calculation unit 154. The loss function calculation unit 151 includes learning loss calculation units 152 and a symmetry loss calculation unit 153.

The learning device 100 performs the learning of a model that calculates the coordinates of the features points in an image. Specifically, the learning device 100 performs the learning of a model such that the model is robust to the orientation of the object that appears in the image. For this purpose, the learning device 100 performs the learning of the model using an original image, and an inverted image in which the original image is axisymmetrically inverted. The axisymmetric inversion of an image referred to here represents inversion of an image using a certain straight line as an axis.

The calculation of the coordinates of the feature points is also referred to as feature point detection. The accuracy of the coordinates of the feature points is also referred to as the feature point detection accuracy.

Hereunder, a case where the learning device 100 learns a model that detects the feature points of a facial image for face recognition will be described as an example. In this case, the model subjected to learning by the learning device 100 calculates the coordinates of feature points indicating the regions where features of the face tend to appear in the facial image, such as the eyes, the nose, and the mouth. As a result of the accuracy of the coordinates being high, in face recognition, it is possible to appropriately normalize the size and tilt of the facial image based on the coordinates. In this respect, it is expected that face recognition can be performed with a high accuracy.

Furthermore, in the case of face recognition, a model being robust to the orientation of an object that appears in the image means that the feature point detection accuracy is about the same regardless of whether the face of the face recognition target is facing the right or facing the left. Here, facing the right or facing the left is not limited to completely facing the right or facing the left, and may also include facing diagonally to the right or facing diagonally to the left.

If there is a difference in the feature point detection accuracy of a facial image depending on whether the facial image is facing the left or right, it is plausible that the recognition accuracy may decrease depending on the orientation of the face, such as in a case where face recognition is more likely to fail in a case where the image is of a face that is facing the right.

In contrast, because the model obtained by the learning performed by the learning device 100 is robust to the orientation of the face, it is expected that face recognition can be performed with a relatively high accuracy regardless of whether the face in the facial image of the recognition target is facing the left or right.

However, the application of the model subjected to learning by the learning device 100 is not limited to a specific application. For example, the learning device 100 may learn a model for pose estimation of a human body, such as a model that detects, as feature points, the positions of the joints in a full-body image of a person.

Alternatively, the learning device 100 may learn a model for detecting minutia (feature points of a fingerprint image, such as the end points or branching points of fingerprint ridges) in fingerprint authentication. In this way, a model that has been trained by the learning device 100 can be used for various biometric authentication performed using images.

Furthermore, the axisymmetric inversion of an image by the learning device 100 is not limited to horizontal inversion. For example, in the case of pose estimation of a human body, the learning device 100 may perform a vertical inversion of an image of a person that is lying sideways.

The training data acquisition unit 110 acquires training data for the learning of a model. Specifically, the training data acquisition unit 110 acquires supervised learning data including sample data of the facial images, and teacher data indicating the correct values of the coordinates of the feature points of the facial images.

The training data acquisition unit 110 corresponds to an example of a training data acquisition means.

The image inversion unit 120 generates facial images in which the facial images included in the training data are horizontally inverted. The images prior to horizontal inversion are also referred to as original images, and the generated images are also referred to as inverted images or horizontally inverted images.

The image inversion unit 120 corresponds to an example of an image inversion means.

The feature point coordinate calculation unit 130 calculates the coordinates of the feature points of the original images, and the coordinates of the feature points of the inverted images. The feature point coordinate calculation unit 130 corresponds to an example of a feature point coordinate calculation means.

In the configuration of FIG. 1, the learning device 100 includes two feature point coordinate calculation units 130, namely a feature point coordinate calculation unit 130 that calculates the coordinates of the feature points of the original image, and a feature point coordinate calculation unit 130 that calculates the coordinates of the feature points of the inverted image. In a case where the two feature point coordinate calculation units 130 are to be distinguished, the feature point coordinate calculation unit 130 that calculates the coordinates of the feature points of the original image is referred to as the feature point coordinate calculation unit 130-1. Furthermore, the feature point coordinate calculation unit 130 that calculates the coordinates of the feature points of the inverted image is referred to as the feature point coordinate calculation unit 130-2.

A convolutional neural network 131 receives an input of a facial image, and outputs the feature amount of the facial image in the form of a feature vector. The number of dimensions of the feature vector output by the convolutional neural network 131 is not limited to a specific number of dimensions. For example, the convolutional neural network 131 may output a 1024-dimensional feature vector, or a 2048-dimensional feature vector. Alternatively, the convolutional neural network 131 may output a feature vector having a different number of dimensions to the number of dimensions above.

The convolutional neural network 131 may output a feature vector in a matrix format such as image data format.

In a case where distinguishing between the convolutional neural network 131 provided in the feature point coordinate calculation unit 130-1 and the convolutional neural network 131 provided in the feature point coordinate calculation unit 130-2, the convolutional neural network 131 provided in the feature point coordinate calculation unit 130-1 is referred to as the convolutional neural network 131-1. Furthermore, the convolutional neural network 131 provided in the feature point coordinate calculation unit 130-2 is referred to as the convolutional neural network 131-2.

A fully connected layer neural network 132 converts the feature vector output by the convolutional neural network 131 into the coordinates of the feature points of the facial image. For example, in a case where the number of feature points to be detected by the feature point coordinate calculation unit 130 is fixed to 5, the fully connected layer neural network 132 may output a 10-dimensional vector (2 dimensions×5 feature points).

In a case where distinguishing between the fully connected layer neural network 132 provided in the feature point coordinate calculation unit 130-1 and the fully connected layer neural network 132 provided in the feature point coordinate calculation unit 130-2, the fully connected layer neural network 132 provided in the feature point coordinate calculation unit 130-1 is referred to as the fully connected layer neural network 132-1. Furthermore, the fully connected layer neural network 132 provided in the feature point coordinate calculation unit 130-2 is referred to as the fully connected layer neural network 132-2.

The combination of a convolutional neural network 131 and a fully connected layer neural network 132 corresponds to an example of a model that calculates the coordinates of the feature points of an image, which is a model subjected to learning by the learning device 100.

The convolutional neural network 131-1 and the convolutional neural network 131-2 are configured as convolutional neural networks having the same structure. The fully connected layer neural network 132-1 and the fully connected layer neural network 132-2 are configured as fully connected layer neural networks having the same structure. The combination of the convolutional neural network 131-1 and the fully connected layer neural network 132-1 corresponds to an example of a first model. The combination of the convolutional neural network 131-2 and the fully connected layer neural network 132-2 corresponds to an example of a second model.

In the learning, the learning device 100 sets the parameter values of the convolutional neural network 131-1 and the parameter values of the convolutional neural network 131-2 to the same values. Furthermore, the learning device 100 sets the parameter values of the fully connected layer neural network 132-1 and the parameter values of the fully connected layer neural network 132-2 to the same values. As a result, the model obtained by combining the convolutional neural network 131-1 and the fully connected layer neural network 132-1, and the model obtained by combining the convolutional neural network 131-2 and the fully connected layer neural network 132-2 are configured as the same model.

The learning of the convolutional neural network 131-1 and the fully connected layer neural network 132-1 is also referred to as the learning of the feature point coordinate calculation unit 130-1. The learning of the convolutional neural network 131-2 and the fully connected layer neural network 132-2 is also referred to as the learning of the feature point coordinate calculation unit 130-2. The learning of the feature point coordinate calculation unit 130-1 and the learning of the feature point coordinate calculation unit 130-2 is collectively referred to as the learning of the feature point coordinate calculation units 130.

However, the model subjected to learning by the learning device 100 is not limited to a model having a specific format. Various models that receive an image input, output the coordinates of the feature points of the image, and can be learned, can be used as the model subjected to learning by the learning device 100.

The coordinate inversion unit 140 performs coordinate conversion of the coordinates of the feature points calculated by the feature point coordinate calculation unit 130-2 so as to cancel out the effect of image inversion. Specifically, the coordinate inversion unit 140 converts the coordinates of the feature points so as to horizontally invert the feature points using the same axis as the axis the image inversion unit 120 used to convert the image. The coordinate conversion performed by the coordinate inversion unit 140 corresponds to an example of a coordinate conversion that is performed so as to cancel out a difference in coordinates between the coordinates of the feature points of the original image and the coordinates of the feature points of the inverted image due to the effect of image inversion.

However, the coordinate conversion that is performed so as to cancel out a difference in coordinates between the coordinates of the feature points of the original image and the coordinates of the feature points of the inverted image due to the effect of image inversion is not limited to the image conversion by the coordinate inversion unit 140 described above. For example, instead of converting the coordinates of the feature points of the inverted image, the coordinate inversion unit 140 may perform a coordinate conversion that is equivalent to the coordinate conversion of the image inversion performed by the image inversion unit 120 with respect to both the coordinates of the feature points of the original image calculated by the feature point coordinate calculation unit 130-1, and the correct coordinates of the feature points of the original image.

The learning control unit 150 controls the learning of the feature point coordinate calculation units 130. Specifically, the learning control unit 150 calculates update amounts of the parameters of the convolutional neural network 131-1, the fully connected layer neural network 132-1, the convolutional neural network 131-2, and the fully connected layer neural network 132-2. Then, the learning control unit 150 controls the feature point coordinate calculation units 130, and changes the parameter values by the calculated update amounts.

Updating the parameter values of a model based on the training data is referred to as learning. Performing a control so as to cause the learning is referred to as controlling the learning.

In particular, the learning control unit 150 controls the learning of the feature point coordinate calculation units 130 so as to reduce the degree of difference between the coordinates of the feature points of the original image calculated by the feature point coordinate calculation unit 130-1, and the coordinates of the feature points of the inverted image calculated by the feature point coordinate calculation unit 130-2 that have been converted by the coordinate inversion unit 140. Specifically, the learning control unit 150 controls the learning of the feature point coordinate calculation units 130 so as to reduce a total loss value calculated by the loss function calculation unit 151, such as by minimizing or locally reducing the total loss value. The total loss value is also referred to as a total loss value. The total loss value corresponds to an example of a total evaluation value.

However, the evaluation function used by the learning control unit 150 in the learning of the feature point coordinate calculation units 130 is not limited to a loss function. The learning control unit 150 may also use an evaluation function whose evaluation function value increases as the accuracy of the coordinates of the feature points calculated by the feature point coordinate calculation units 130 increases.

Furthermore, the learning control unit 150 controls the learning of the feature point coordinate calculation units 130 such that the same parameter values are set to the convolutional neural network 131-1 and the convolutional neural network 131-2, and the same parameter values are set to the fully connected layer neural network 132-1 and the fully connected layer neural network 132-2. As a result, the model obtained by combining the convolutional neural network 131-1 and the fully connected layer neural network 132-1, and the model obtained by combining the convolutional neural network 131-2 and the fully connected layer neural network 132-2 are configured as the same model.

The loss function calculation unit 151 calculates the value of the loss function that is used in the learning of the feature point coordinate calculation units 130.

The learning loss calculation unit 152 calculates a learning loss. The learning loss is also referred to as the learning loss. The learning loss indicates the degree of difference between the coordinates of the feature points calculated by the feature point coordinate calculation units 130 and the correct coordinates indicated in the training data.

The loss function calculation unit 151 includes learning loss calculation units 152 for each of the original image and the inverted image. In a case where the two learning loss calculation units 152 are to be distinguished, the learning loss calculation unit 152 on the original image side is referred to as the learning loss calculation unit 152-1, and the learning loss calculation unit 152 on the inverted image side is referred to as the learning loss calculation unit 152-2.

The learning loss calculation unit 152-1 calculates a learning loss that indicates the degree of difference between the coordinates of the feature points of the original image calculated by the feature point coordinate calculation unit 130-1, and the correct coordinates indicated in the training data. The learning loss calculated by the learning loss calculation unit 152-1 is also referred to as a first learning loss, or the learning loss of the original image. The first learning loss corresponds to an example of a first learning evaluation value. The learning loss calculation unit 152-1 corresponds to an example of a first learning evaluation value calculation means.

The learning loss calculation unit 152-2 calculates a learning loss that indicates the degree of difference between the coordinates of the feature points of the original image calculated by the feature point coordinate calculation unit 130-2 that have been converted by the coordinate inversion unit 140, and the correct coordinates indicated in the training data. The learning loss calculated by the learning loss calculation unit 152-2 is also referred to as a second learning loss or the learning loss of the inverted image. The second learning loss corresponds to an example of a second learning evaluation value. The learning loss calculation unit 152-2 corresponds to an example of a second learning evaluation value calculation means.

As the training loss, various losses based on distances between coordinates can be used. For example, the learning loss calculation units 152 may use any one of an L2 loss, an L1 loss, or a Wing loss as the learning loss, but are not limited to these.

The symmetry loss calculation unit 153 calculates a symmetry loss indicating the degree of difference between the coordinates of the feature points of the original image calculated by the feature point coordinate calculation unit 130-1, and the coordinates of the feature points of the inverted image calculated by the feature point coordinate calculation unit 130-2 that have been converted by the coordinate inversion unit 140. The symmetry loss is also referred to as the symmetry loss.

The symmetry loss corresponds to an example of a symmetry evaluation value. The symmetry loss calculation unit 153 corresponds to an example of a symmetry evaluation value calculation means.

As the symmetry loss, various losses based on distances between coordinates can be used. For example, the symmetry loss calculation unit 153 may use any one of an L2 loss, an L1 loss, or a Wing loss as the symmetry loss, but is not limited to these.

The symmetry loss calculation unit 153 may output the symmetry loss to the outside of the learning device 100. In this case, the symmetry loss calculation unit 153 corresponds to an example of an output means. Furthermore, the learning device 100 corresponds to an example of a symmetry evaluation device.

For example, the symmetry loss calculation unit 153 may have a display screen, and display the symmetry loss as a numerical value. Alternatively, the symmetry loss calculation unit 153 may have a communication function, and transmit data indicating the symmetry loss to another device.

The user of the learning device 100 can confirm how robust the feature point coordinate calculation unit 130 is to the orientation of the face, by referring to the symmetry loss.

The loss function calculation unit 151 calculates the total loss value based on the first learning loss, the second learning loss, and the symmetry loss. The loss function calculation unit 151 calculates the total loss value such that; the total loss value becomes larger as the value of the first learning loss becomes larger, the total loss value becomes larger as the value of the second learning loss becomes larger, and the total loss value becomes larger as the value of the symmetry loss becomes larger. For example, the loss function calculation unit 151 may calculate the sum of the first learning loss, the second learning loss, and the symmetry loss as the total loss value, but it is not limited to this.

As described above, the learning control unit 150 controls the learning of the feature point coordinate calculation units 130 so as to reduce the total loss value. In this respect, the learning control unit 150 controls the learning of the feature point coordinate calculation units 130 so as to reduce the degree of difference indicated by the symmetry evaluation value.

The update amount calculation unit 154 calculates, based on the total loss value, update amounts of the parameter values of the convolutional neural networks 131 and the fully connected layer neural networks 132. The update amount calculation unit 154 may use backpropagation as the method of calculating the update amounts of the parameter values, but it is not limited to this. The update amount calculation unit 154 may use various methods in a regression learning framework as the method of calculating the update amounts of the parameter values.

The update amount calculation unit 154 calculates the same parameter value update amounts so as to set the same parameter values to the convolutional neural network 131-1 and the convolutional neural network 131-2. For example, the update amount calculation unit 154 may calculate update amounts for the parameters of the convolutional neural network 131-1 and update amounts for the parameters of the convolutional neural network 131-2. Then, the update amount calculation unit 154 may calculate the sum of the update amounts as parameter value update amounts that are shared by the convolutional neural network 131-1 and the convolutional neural network 131-2.

The update amount calculation unit 154 calculates a parameter value update amount for each parameter subjected to learning that is included in the convolutional neural networks 131.

Furthermore, the update amount calculation unit 154 calculates the same parameter value update amounts so as to set the same parameter values to the fully connected layer neural network 132-1 and the fully connected layer neural network 132-2. For example, the update amount calculation unit 154 may calculate update amounts for the parameters of the fully connected layer neural network 132-1 and update amounts for the parameters of the fully connected layer neural network 132-2. Then, the update amount calculation unit 154 may calculate the sum of the update amounts as parameter value update amounts that are shared by the fully connected layer neural network 132-1 and the fully connected layer neural network 132-2.

The update amount calculation unit 154 calculates a parameter value update amount for each parameter subjected to learning that is included in the fully connected layer neural networks 132.

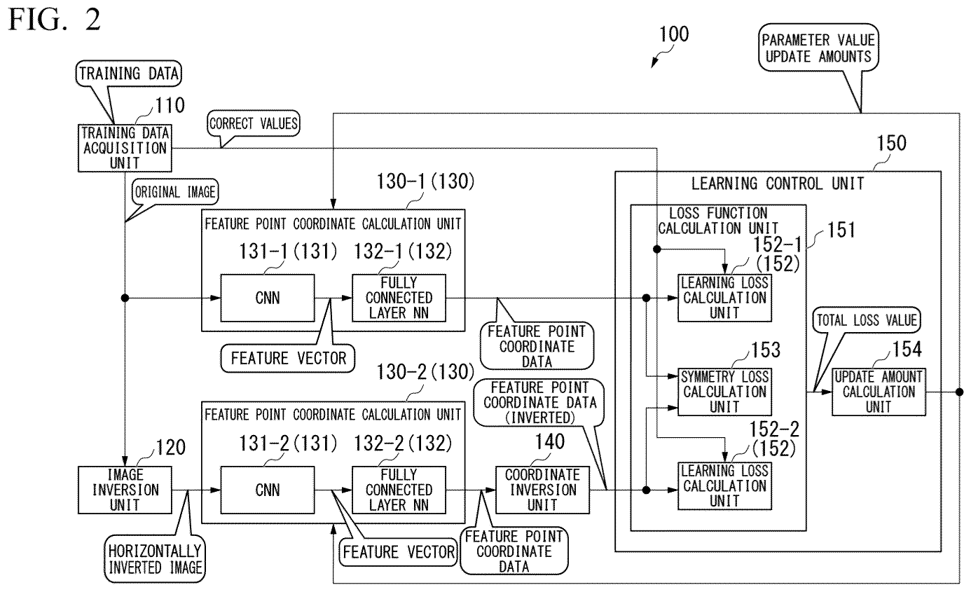

FIG. 2 is a diagram showing an example of data input and output in the learning device 100.

In the example of FIG. 2, the training data acquisition unit 110 acquires training data, and outputs the image data included in the training data to the image inversion unit 120 and the convolutional neural network 131-1. The image data that is output by the training data acquisition unit 110 corresponds to the original image data. Moreover, the training data acquisition unit 110 outputs the correct data of the coordinates of the feature amounts associated with the output image data, to the learning loss calculation unit 152-1 and the learning loss calculation unit 152-2.

The image inversion unit 120 generates the image data of the inverted image, in which the original image represented by the image data output by the training data acquisition unit 110 has been inverted, and outputs the data to the convolutional neural network 131-2.

In the feature point coordinate calculation unit 130-1, the convolutional neural network 131-1 receives an input of the image data of the original image from the training data acquisition unit 110, and outputs feature vector data of the original image to the fully connected layer neural network 132-1. The fully connected layer neural network 132-1 receives an input of the feature vector data of the original image output by the convolutional neural network 131-1, and outputs the coordinate data of the feature points of the original image to the learning loss calculation unit 152-1 and the symmetry loss calculation unit 153.

In the feature point coordinate calculation unit 130-2, the convolutional neural network 131-2 receives an input of the image data of the inverted image from the image inversion unit 120, and outputs solution amount vector data of the inverted image to the fully connected layer neural network 132-2. The fully connected layer neural network 132-2 receives an input of the feature vector data of the inverted image output by the convolutional neural network 131-2, and outputs the coordinate data of the feature points of the inverted image to the coordinate inversion unit 140.

The coordinate inversion unit 140 receives an input of the coordinate data of the feature points of the inverted image from the fully connected layer neural network 132-2, and performs coordinate conversion of the coordinates of the feature points of the inverted image as described above. The coordinate inversion unit 140 outputs the coordinate data indicating the converted coordinates, to the symmetry loss calculation unit 153 and the learning loss calculation unit 152-2.

In the loss function calculation unit 151, the learning loss calculation unit 152-1 calculates the first learning loss based on the coordinate data of the feature points of the original image from the fully connected layer neural network 132-1, and the correct data from the training data acquisition unit 110.

The learning loss calculation unit 152-2 calculates the second learning loss based on the coordinate data of the feature points of the inverted image after coordinate conversion by the coordinate inversion unit 140 and the correct data from the training data acquisition unit 110.

The symmetry loss calculation unit 153 calculates the symmetry loss based on the coordinate data of the feature points of the original image from the fully connected layer neural network 132-1, and the coordinate data of the feature points of the inverted image after coordinate conversion by the coordinate inversion unit 140.

The loss function calculation unit 151 calculates the total loss value based on the first learning loss, the second learning loss, and the symmetry loss, and outputs the total loss value to the update amount calculation unit 154.

The update amount calculation unit 154 calculates, based on the total loss value from the loss function calculation unit 151, update amounts of the parameter values of the convolutional neural networks 131 and the fully connected layer neural networks 132. The update amount calculation unit 154 outputs the calculated update amounts to the feature point coordinate calculation units 130-1 and 130-2, and updates the parameter values of the convolutional neural networks 131 and the fully connected layer neural networks 132.

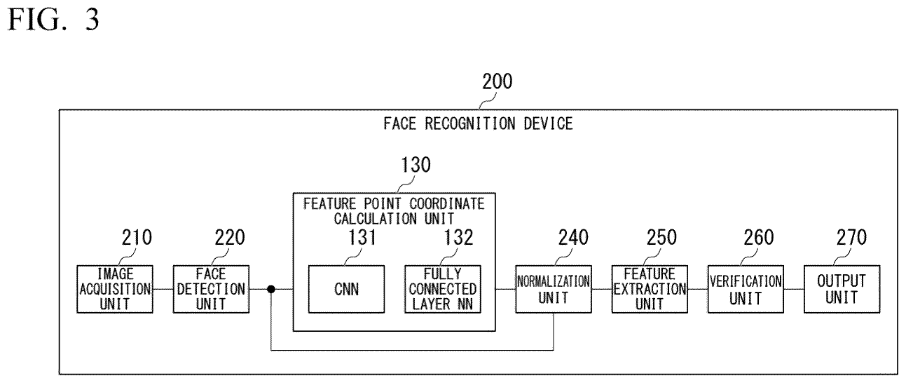

FIG. 3 is a diagram showing an example of a configuration of a face recognition device using a feature point coordinate calculation unit 130 that has been trained by the learning device 100. In the configuration shown in FIG. 3, the face recognition device 200 includes an image acquisition unit 210, a face detection unit 220, a feature point coordinate calculation unit 130, a normalization unit 240, a feature extraction unit 250, a verification unit 260, and an output unit 270. The feature point coordinate calculation unit 130 includes a convolutional neural network 131 and a fully connected layer neural network 132.

The feature point coordinate calculation unit 130 provided in the face recognition device 200 has been trained by the learning device 100. In FIG. 3, the feature point coordinate calculation unit 130 and the units thereof are given the same reference symbols (130, 131, and 132) as in FIG. 1.

The face recognition device 200 receives an input of a facial image and performs face recognition with respect to the facial image that has been input. However, as mentioned above, the application of the feature point coordinate calculation unit 130 that has been trained by the learning device 100 is not limited to face recognition.

The image acquisition unit 210 acquires a facial image of a recognition target.

The face detection unit 220 detects the section of the facial image acquired by the image acquisition unit 210 that contains the face.

The feature point coordinate calculation unit 130 calculates the coordinates of the feature points from the section of the facial image containing the face that has been detected by the face detection unit 220.

Here, the feature point coordinate calculation units 130-1 and 130-2 in FIG. 1 are the same. In particular, the convolutional neural networks 131-1 and 131-2 are the same model. Furthermore, the fully connected layer neural networks 132-1 and 132-2 are the same model. Therefore, either of the feature point coordinate calculating units 130-1 or 130-2 may be used as the feature point coordinate calculation unit 130 of the face recognition device 200.

The convolutional neural network 131 calculates a feature vector from the section of the facial image containing the face. The fully connected layer neural network 132 converts the feature vector calculated by the convolutional neural network 131 into the coordinates of the feature points. However, the configuration of the model included in the feature point coordinate calculation unit 130 is not limited to a specific configuration.

The normalization unit 240 performs normalization that, based on the coordinates of the feature points calculated by the feature point coordinate calculation unit 130, aligns the size and orientation of the facial image, in which the section containing the face has been detected by the face detection unit 220.

The feature extraction unit 250 calculates a feature vector from the facial image that has been normalized by the normalization unit 240. The feature vector calculated by the feature extraction unit 250 corresponds to feature amounts of a facial image for face recognition.

The verification unit 260 performs face recognition by comparing the feature vector calculated by the feature extraction unit 250 and the feature vectors of the facial images that have been registered in advance.

The output unit 270 outputs the result of the face recognition performed by the verification unit 260.

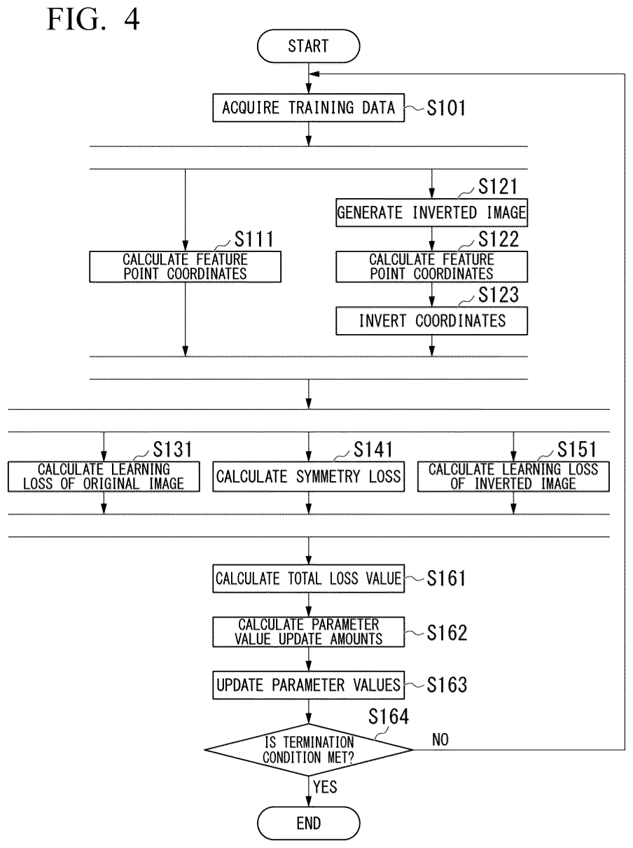

FIG. 4 is a diagram showing an example of the processing procedure by which the learning device 100 performs the learning of the feature point coordinate calculation unit 130.

### (Step S101)

The training data acquisition unit 110 reads a combination consisting of a facial image and the correct coordinates of the feature points of the facial image, from the training data. The facial image read by the training data acquisition unit 110 from the training images corresponds to an example of an original image.

After step S101, the processing branches to step S111 and step S121. Step S111 and steps S121 to S123 can be executed in parallel.

### (Step S111)

The feature point coordinate calculation unit 130-1 calculates the coordinates of the feature points of the original image.

### (Step S121)

The image inversion unit 120 generates an inverted image in which the original image has been horizontally inverted.

After step S121, the processing proceeds to step S122.

### (Step S122)

The feature point coordinate calculation unit 130-2 calculates the coordinates of the feature points of the inverted image.

After step S122, the processing proceeds to step S123.

### (Step S123)

The coordinate inversion unit 140 performs coordinate conversion with respect to the coordinates of the feature points of the inverted image that have been calculated by the feature point coordinate calculation unit 130-2, so as to cancel out an effect of horizontal inversion of the image by the image inversion unit 120.

After steps S111 and S123, the processing branches to step S131, step S141, and step S151. Step S131, step S141, and step S151 can be executed in parallel.

### (Step S131)

The learning loss calculation unit 152-1 calculates the learning loss (first learning loss) of the original image based on the coordinates of the feature points of the original image calculated by the feature point coordinate calculation unit 130-1, and the correct coordinates indicated in the training data.

(step S141)

The symmetry loss calculation unit 153 calculates the symmetry loss based on the coordinates of the feature points of the original image calculated by the feature point coordinate calculation unit 130-1, and the coordinates of the feature points of the inverted image calculated by the feature point coordinate calculation unit 130-2 that have been converted by the coordinate inversion unit 140.

### (Step S151)

The learning loss calculation unit 152-2 calculates the learning loss (second learning loss) of the inverted image based on the coordinates of the feature points of the original image calculated by the feature point coordinate calculation unit 130-2 that have been converted by coordinate inversion unit 140, and the correct coordinates indicated in the training data.

After step S131, step S141, and step S151, the processing shifts to step S161.

### (Step S161)

The loss function calculation unit 151 calculates a total loss value based on the first learning loss, the second learning loss, and the symmetry loss.

After step S161, the processing proceeds to step S162.

### (Step S162)

The update amount calculation unit 154 calculates, based on the total loss value, update amounts of the parameter values of the convolutional neural networks 131 and the fully connected layer neural networks 132.

After step S162, the processing proceeds to step S163.

### (Step S163)

The feature point coordinate calculation unit 130 updates the parameter values of the convolutional neural networks 131 and the fully connected layer neural network 132, based on the update amounts of the parameter values calculated by the update amount calculation unit 154.

After step S163, the processing proceeds to step S164.

### (Step S164)

The learning control unit 150 determines whether or not a termination condition of the learning is met. The termination condition of the learning referred to here is not limited to a specific condition. For example, as the termination condition of the learning, a condition may be used in which it is determined whether or not the accuracy of the coordinates of the feature points calculated by the feature point coordinate calculation unit 130 is greater than or equal to a predetermined threshold. Alternatively, as the termination condition of the learning, a condition may be used in which it is determined whether or not the learning has been performed for a predetermined number of epochs.

If the learning control unit 150 determines that the termination condition of the learning is not met (step S164: NO), the processing returns to step S101.

On the other hand, if the learning control unit 150 determines that the termination condition of the learning is met (step S164: YES), the learning device 100 terminates the processing of FIG. 4.

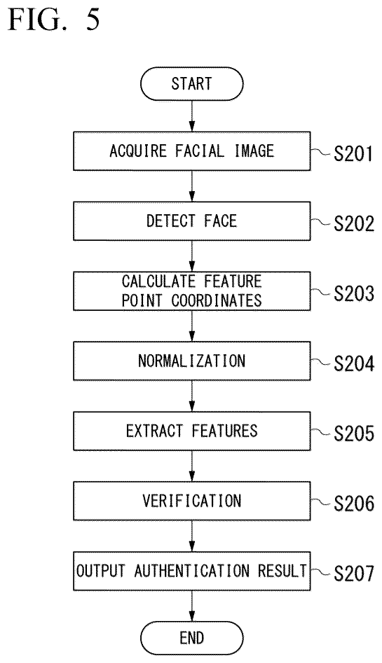

FIG. 5 is a diagram showing an example of the processing sequence by which the face recognition device 200 performs face recognition.

### (Step S201)

The image acquisition unit 210 acquires a facial image of a recognition target.

After step S201, the processing proceeds to step S202.

### (Step S202)

The face detection unit 220 detects the section of the facial image of the recognition target that contains the face.

After step S202, the processing proceeds to step S203.

### (Step S203)

The feature point coordinate calculation unit 130 calculates the coordinates of the feature points from the section of the facial image containing the face, which has been detected by the face detection unit 220.

After step S203, the processing proceeds to step S204.

### (Step S204)

The normalization unit 240 performs normalization that, based on the coordinates of the feature points calculated by the feature point coordinate calculation unit 130, aligns the size and orientation of the facial image, in which the section containing the face has been detected by the face detection unit 220.

After step S204, the processing proceeds to step S205.

### (Step S205)

The feature extraction unit 250 calculates a feature vector from the facial image that has been normalized by the normalization unit 240.

After step S205, the processing proceeds to step S206.

### (Step S206)

The verification unit 260 performs face recognition by comparing the feature vector calculated by the feature extraction unit 250 and the feature vectors of the facial images that have been registered in advance.

After step S206, the processing proceeds to step S207.

### (Step S207)

The output unit 270 outputs the result of the face recognition performed by the verification unit 260.

After step S207, the face recognition device 200 ends the processing of FIG. 5.

As described above, the training data acquisition unit 110 acquires training data including the original image. The image inversion unit 120 generates an inverted image in which the original image has been axisymmetrically inverted. The feature point coordinate calculation unit 130 calculates the coordinates of the feature points of the original image, and the coordinates of the feature points of the inverted image. The symmetry loss calculation unit 153 calculates a symmetry loss that indicates the degree of difference between the coordinates of the feature points of the original image and the coordinates of the feature points of the inverted image in a case where coordinate conversion is performed so as to cancel out a difference in coordinates between the coordinates of the feature points of the original image and the coordinates of the feature points of the inverted image due to the effect of image inversion. The learning control unit 150 controls the learning of the feature point coordinate calculation units 130 so as to reduce the degree of difference indicated by the symmetry loss.

According to the learning device 100, as a result of the feature point coordinate calculation units 130 performing the learning so as to reduce the degree of difference indicated by the symmetry loss, the symmetry between the original image and the inverted image, in which the original image has been horizontally inverted, can be reflected in the learning of the feature point coordinate calculation units 130. According to the learning device 100, in a case where facial image data is input to the trained feature point coordinate calculation units 130, it is possible to reduce the asymmetry of the obtained coordinates depending on whether the face is facing the left or right, such as a case where the accuracy of the obtained coordinates is low in a case where the face is facing the left, or the coordinates of the feature points are more likely to be detected further toward the inside than the actual coordinates in a case where the face is facing the right, and the coordinates of the feature points are more likely to be detected further toward the outside than the actual coordinates in a case where the face is facing the left. In this respect, according to the learning device 100, the coordinates of the feature points of the image can be obtained with a high accuracy.

Furthermore, the feature point coordinate calculation units 130 use the second model having the same structure as the first model, which is used to calculate the coordinates of the feature points of the original image, to calculate the coordinates of the feature points of the inverted image. The learning control unit 150 controls the learning of the feature point coordinate calculation units 130 such that the same parameter values are set to the first model and the second model.

According to the learning device 100, it is possible to execute the processing with respect to the original image and the processing with respect to the inverted image in parallel, and further, the asymmetry of the obtained coordinates depending on whether the face is facing the left or right can be reduced.

In addition, the learning loss calculation unit 152-1 calculates the first learning loss, which indicates the degree of difference between the coordinates of the feature points of the original image and the correct values of the coordinates of the feature points of the original image indicated in the training data. The learning loss calculation unit 152-2 calculates the second learning loss, which indicates the degree of difference between the coordinates of the feature points of the inverted image obtained in a case where coordinate conversion is performed so as to cancel out a difference in coordinates due to the effect of image inversion, and the correct values. The learning control unit 150 controls the learning of the feature point coordinate calculation units 130 so as to reduce the total loss value based on the symmetry loss, the first learning loss, and the second peripheral loss.

According to the learning device 100, regardless of whether the facial image is facing the left or right, the coordinates of the feature points calculated by the feature point coordinate calculation unit 130 can be made to approach the correct coordinates, or coordinates in which the correct coordinates have been horizontally inverted in the same manner as the image. In this respect, according to the learning device 100, the asymmetry of the coordinates obtained depending on whether the face is facing the left or right can be reduced, and further, it is expected that the coordinates of the feature points can be obtained with a high accuracy.

In addition, the face recognition device 200 includes the feature point coordinate calculation unit 130 that has been trained by the learning device 100 described above.

According to the face recognition device 200, regardless of whether the face is facing the left or right, the coordinates of the feature points of the facial image can be described as being obtained with a relatively high accuracy. As a result, in the face recognition device 200, regardless of whether the face is facing the left or right, it is expected that face recognition can be performed with a relatively high accuracy.

Furthermore, the symmetry loss calculation unit 153 outputs a symmetry loss that indicates the degree of difference between the coordinates of the feature points of the original image and the coordinates of the feature points of the inverted image, in which the original image has been horizontally inverted, in a case where coordinate conversion is performed so as to cancel out a difference in coordinates between the coordinates of the feature points of the original image and the coordinates of the feature points of the inverted image due to the effect of image inversion.

The user of the learning device 100 can confirm how robust the feature point coordinate calculation unit 130 is to the orientation of the face by referring to the symmetry loss.

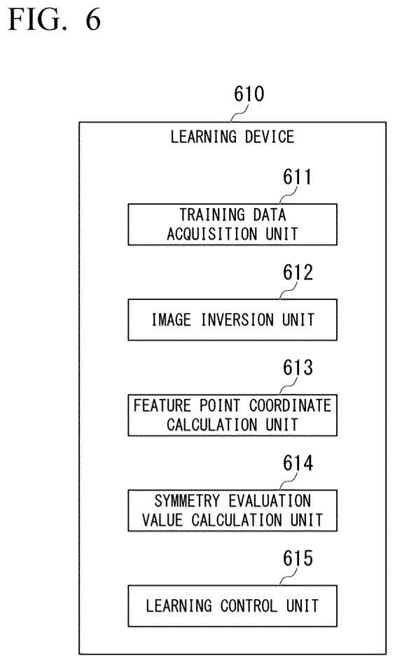

FIG. 6 is a diagram showing another example of a configuration of a learning device according to the example embodiment. In the configuration shown in FIG. 6, the learning device 610 includes a training data acquisition unit 611, an image inversion unit 612, a feature point coordinate calculation unit 613, a symmetry evaluation value calculation unit 614, and a learning control unit 615.

In such a configuration, the training data acquisition unit 611 acquires training data including the original image. The image inversion unit 612 generates an inverted image in which the original image has been axisymmetrically inverted. The feature point coordinate calculation unit 613 calculates the coordinates of the feature points of the original image, and the coordinates of the feature points of the inverted image. The symmetry loss calculation unit 614 calculates a symmetry evaluation value that indicates the degree of difference between the coordinates of the feature points of the original image and the coordinates of the feature points of the inverted image in a case where coordinate conversion is performed so as to cancel out a difference in coordinates between the coordinates of the feature points of the original image and the coordinates of the feature points of the inverted image due to the effect of image inversion. The learning control unit 615 controls the learning of the feature point coordinate calculation unit 613 so as to reduce the degree of difference indicated by the symmetry evaluation value.

The training data acquisition unit 611 corresponds to an example of a training data acquisition means. The image inversion unit 612 corresponds to an example of an image inversion means. The feature point coordinate calculation unit 613 corresponds to an example of a feature point coordinate calculation means. The symmetry evaluation value calculation unit 614 corresponds to an example of a symmetry evaluation value calculation means. The learning control unit 615 corresponds to an example of the learning control means.

According to the learning device 610, as a result of the feature point coordinate calculation unit 613 performing the learning so as to reduce the degree of difference indicated by the symmetry evaluation value, the symmetry between the original image and the inverted image, in which the original image has been axisymmetrically inverted, can be reflected in the learning of the feature point coordinate calculation unit 613. According to the learning device 610, in a case where image data is input to the trained feature point coordinate calculation unit 613, it is possible to reduce the asymmetry of the obtained coordinates depending on the orientation of the object that appears in the image, such as a case where the accuracy of the obtained coordinates is low in a case where the image is facing the left, or the coordinates of the feature points are more likely to be detected further toward the inside than the actual coordinates in a case where the image is facing the right, and the coordinates of the feature points are more likely to be detected further toward the outside than the actual coordinates in a case where the image is facing the left. In this respect, according to the learning device 610, the coordinates of the feature points of the image can be obtained with a high accuracy.

FIG. 7 is a diagram showing an example of the processing procedure of a learning method according to the example embodiment. The method shown in FIG. 7 includes the steps of acquiring training data (step S611), generating an inverted image (step S612), calculating feature point coordinates (step S613), calculating a symmetry evaluation value (step S614), and controlling learning (step S615).

In the step of acquiring training data (step S611), a computer acquires training data including an original image and the correct values of the coordinates of the feature points of the original image.

In the step of generating an inverted image (step S612), a computer generates an inverted image in which the original image has been axisymmetrically inverted.

In the step of calculating feature point coordinates (step S613), a computer calculates the coordinates of the feature points of the original image, and the coordinates of the feature points of the inverted image.

In the step of calculating a symmetry evaluation value (step S614), a computer calculates a symmetry evaluation value that indicates a degree of difference between the coordinates of the feature points of the original image and the coordinates of the feature points of the inverted image in a case where coordinate conversion is performed so as to cancel out a difference in coordinates between the coordinates of the feature points of the original image and the coordinates of the feature points of the inverted image due to the effect of image inversion.

In the step of controlling learning (step S615), a computer controls the learning of a model that calculates the coordinates of the feature points so as to reduce the degree of difference indicated by the symmetry evaluation value.

According to the learning method shown in FIG. 7, as a result of learning the model so as to reduce the degree of difference indicated by the symmetry evaluation value, the symmetry between the original image and the inverted image, in which the original image has been axisymmetrically inverted, can be reflected in the learning of the model. According to the learning method shown in FIG. 7, in a case where image data is input to the trained model, it is possible to reduce the asymmetry of the obtained coordinates depending on the orientation of the object that appears in the image, such as a case where the accuracy of the obtained coordinates is low in a case where the image is facing the left, or the coordinates of the feature points are more likely to be detected further toward the inside than the actual coordinates in a case where the image is facing the right, and the coordinates of the feature points are more likely to be detected further toward the outside than the actual coordinates in a case where the image is facing the left. In this respect, according to the learning method shown in FIG. 7, the coordinates of the feature points of the image can be obtained with a high accuracy.

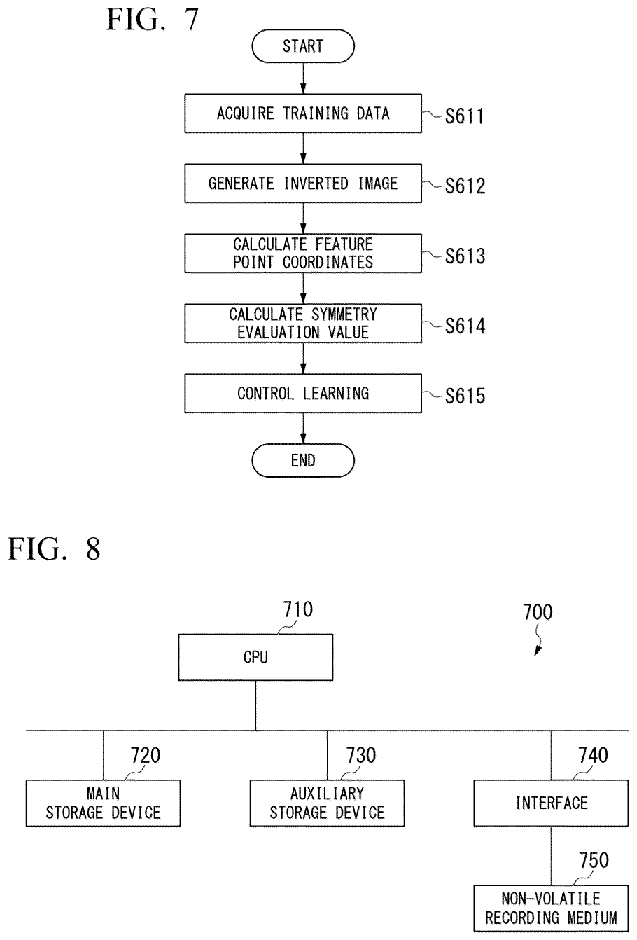

FIG. 8 is a schematic block diagram showing a configuration of a computer according to at least one example embodiment.

In the configuration shown in FIG. 8, a computer 700 includes a CPU (central processing unit) 710, a main storage device 720, an auxiliary storage device 730, an interface 740, and a non-volatile recording medium 750.

Any one or more of the learning device 100, the face recognition device 200, the learning device 610, or a portion thereof, may be implemented by the computer 700. In this case, the operation of each of the processing units described above is stored in the auxiliary storage device 730 in the form of a program. The CPU 710 reads the program from the auxiliary storage device 730, expands the program in the main storage device 720, and executes the processing described above according to the program. Further, the CPU 710 secures a storage area corresponding to each of the storage units in the main storage device 720 according to the program. The communication of each device with other devices is executed as a result of the interface 740 having a communication function and performing communication according to the control of the CPU 710.

In a case where the learning device 100 is implemented by the computer 700, the operation of each unit thereof is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area in the main storage device 720 for the learning device 100 to perform processing according to the program. The communication of the learning device 100 with other devices is executed as a result of the interface 740 having a communication function and performing communication according to the control of the CPU 710. The interactions between the learning device 100 and the user are executed as a result of the interface 740 having a display device and an input device, various images being displayed according to control by the CPU 710, and receiving a user input.

In a case where the face recognition device 200 is implemented by the computer 700, the operation of each unit thereof is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area in the main storage device 720 for the face recognition device 200 to perform processing according to the program. The communication of the face recognition device 200 with other devices is executed as a result of the interface 740 having a communication function and performing communication according to the control of the CPU 710. The interactions between the face recognition device 200 and the user are executed as a result of the interface 740 having a display device and an input device, various images being displayed according to control by the CPU 710, and receiving a user input.

In a case where the learning device 610 is implemented by the computer 700, the operation of each unit thereof is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area in the main storage device 720 for the learning device 610 to perform processing according to the program. The communication of the learning device 610 with other devices is executed as a result of the interface 740 having a communication function and performing communication according to the control of the CPU 710. The interactions between the learning device 610 and the user are executed as a result of the interface 740 having a display device and an input device, various images being displayed according to control by the CPU 710, and receiving a user input.

One or more of the programs described above may be recorded in the non-volatile recording medium 750. In this case, the interface 740 may read out the program from the non-volatile recording medium 750. Then, the CPU 710 directly executes the program that has been read out by the interface 740, or executes the program after temporarily saving it in the main storage device 720 or the auxiliary storage device 730.

Furthermore, a program for executing some or all of the processing performed by the learning device 100, the face recognition device 200, and the learning device 610 may be recorded in a computer-readable recording medium, and the processing of each unit may be performed by a computer system reading and executing the program recorded on the recording medium. The “computer system” referred to here is assumed to include an OS (operating system) and hardware such as a peripheral device.

Furthermore, the “computer-readable recording medium” refers to a portable medium such as a flexible disk, a magnetic optical disk, a ROM (read only memory), or a CD-ROM (compact disc read only memory), or a storage device such as a hard disk built into a computer system. Moreover, the program may be one capable of realizing some of the functions described above. Further, the functions described above may be realized in combination with a program already recorded in the computer system.

An example embodiment of the present invention has been described in detail above with reference to the drawings. However, specific configurations are in no way limited to the example embodiment, and include designs and the like within a scope not departing from the spirit of the present invention.

### INDUSTRIAL APPLICABILITY

The present invention may be applied to a learning device, a symmetry evaluation device, a learning method, and a recording medium.

### Description of Reference Signs

100, 610 Learning device
110, 611 Training data acquisition unit
120, 612 Image inversion unit
130, 613 Feature point coordinate calculation unit
131 Convolutional neural network
132 Fully connected layer neural network
140 Coordinate inversion unit
150, 615 Learning control unit
151 Loss function calculation unit
152 Learning loss calculation unit
153 Symmetry loss calculation unit
154 Update amount calculation unit
200 Face recognition device
210 Image acquisition unit
220 Face detection unit
240 Normalization unit
250 Feature extraction unit
260 Verification unit
270 Output unit
614 Symmetry evaluation value calculation unit

What is claimed is:

1. A learning device comprising:
at least one memory configured to store instructions; and
at least one processor configured to execute the instructions to:
acquire training data that includes an original image;
generate an inverted image in which the original image is axisymmetrically inverted;
calculate coordinates of feature points of the original image and coordinates of feature points of the inverted image;
calculate a symmetry evaluation value that indicates a degree of difference between the coordinates of the feature points of the original image and the coordinates of the feature points of the inverted image in a case where coordinate conversion is performed so as to cancel out a difference in coordinates between the coordinates of the feature points of the original image and the coordinates of the feature points of the inverted image due to an effect of image inversion; and
control means that controls control training of a model used for calculating the coordinates such that the degree of difference indicated by the symmetry evaluation value is reduced.

2. The learning device according to claim 1, wherein the at least one processor is configured to execute the instructions to:
use a second model, being a model having the same structure as a first model used to calculate the coordinates of the feature points of the original image, to calculate the coordinates of the feature points of the inverted image; and
control training of the model used for calculating the coordinates such that the same parameter values are set to both the first model and the second model.

3. The learning device according to claim 1, wherein the at least one processor is configured to execute the instructions to:
calculate a first learning evaluation value that indicates a degree of difference between the coordinates of the feature points of the original image and correct values of the coordinates of the feature points of the original image indicated in the training data;
calculate a second learning evaluation value that indicates a degree of difference between the coordinates of the feature points of the inverted image and the correct values in a case where coordinate conversion is performed so as to cancel out a difference in coordinates between the coordinates of the feature points of the inverted image and the correct values due to an effect of image inversion; and
control the training of calculating the coordinates such that an overall evaluation value based on the symmetry evaluation value, the first learning evaluation value, and the second learning evaluation value is reduced.

4. (canceled)

5. A symmetry evaluation device comprising:
at least one memory configured to store instructions; and
at least one processor configured to execute the instructions to:
output a symmetry evaluation value that indicates a degree of difference between coordinates of feature points of an original image and coordinates of feature points of an inverted image, in which the original image has been axisymmetrically inverted, in a case where coordinate conversion is performed so as to cancel out a difference in coordinates between the coordinates of the feature points of the original image and the coordinates of the feature points of the inverted image due to an effect of image inversion.

6. A learning method executed by a computer, the method comprising:
acquiring training data that includes an original image, and correct values of coordinates of feature points of the original image;
generating an inverted image in which the original image is axisymmetrically inverted;
calculating coordinates of feature points of the original image and coordinates of feature points of the inverted image;
calculating a symmetry evaluation value that indicates a degree of difference between the coordinates of the feature points of the original image and the coordinates of the feature points of the inverted image in a case where coordinate conversion is performed so as to cancel out a difference in coordinates between the coordinates of the feature points of the original image and the coordinates of the feature points of the inverted image due to an effect of image inversion; and
controlling training of a model that calculates the coordinates of the feature points such that the degree of difference indicated by the symmetry evaluation value is reduced.

7. (canceled)
